(19) United States
(12) Patent Application Publication
(10) Pub. No.: US 2003/0063853 A1
(43) Pub. Date: Apr. 3, 2003

(54) Wavelength division multiplexed coupler

(76) Inventors: River Huang, Shenzhen (CN); Huishi Li, Shenzhen (CN); Ruiliang Cao, Shenzhen (CN); Xiaobiao Wang, Shenzhen (CN); Weiqi Xue, Shenzhen (CN)

Correspondence Address: Jeff Klembczyk, Intellectual Property Dept., JDS Uniphase Corporation, 3000 Merivale Road, Ottawa, ON, K2G 6N7, CA

(21) Appl. No.: 10/243,908

(22) Filed: Sep. 16, 2002

Related U.S. Application Data
(60) Provisional application No. 60/322,446, filed on Sep. 17, 2001.

(51) Int. Cl. G02B 6/32; G02B 6/26

(52) U.S. Cl. 385/34; 385/33; 385/47

(57) ABSTRACT

The invention provides an optical coupling system having first and second back-to-back GRIN lenses each having an input and an output end face, an optical filter element disposed between the first and second back-to-back GRIN lenses, an input optical fiber tube having two optical fibers therein adjacent to and optically coupled with the first of the back-to-back GRIN lenses, an output optical fiber tube having an optical fiber therein adjacent to and optically coupled with the second of the back-to-back GRIN lenses, wherein an inwardly facing end face of the output optical fiber tube and the output end face of the second of the back-to-back GRIN lenses are non-parallel to each other for reducing coupling losses. The optical coupling system is supported in glass holding tubes.

### CROSS-REFERENCE TO RELATED APPLICATIONS

This applications claims priority of U.S. Provisional Patent Application Ser. No. 60/322,446 filed on Sep. 17, 2001, entitled “All-Glass WDM Project” which is incorporated herein by reference for all purposes.

### MICROFICHE APPENDIX

Not Applicable.

### FIELD OF THE INVENTION

The present invention generally relates to the field of optical fiber technology and, more particularly, to wavelength division multiplexed (WDM) couplers.

### BACKGROUND OF THE INVENTION

In optical fiber technology, wavelength division multiplexed (WDM) couplers are used to combine or separate optical signals having different wavelengths. As the WDM couplers are being more broadly applied in the telecommunications, data communications and CATV industries, the fiber optic component industry is now confronted with increasing requirements for WDM couplers with higher level of performance and reliability.

The performance and reliability of the WDM couplers depend heavily on their design and packaging technologies. Currently, two major kinds of design and packaging technologies are being widely employed in manufacturing the WDM couplers and each kind has its own advantages and disadvantages. In applying a first kind of technology for designing and packaging the WDM couplers, all optical parts are bonded together by applying epoxy bonding. The applications of this first type of WDM couplers show potential reliability risk of epoxy bonding in long-term operation. A second kind of technology includes the use of glass tubes and thin sections of epoxy to realize an epoxy-free optical path in passive fiber-optic components, while maintaining simplicity and low cost. This approach has been realized in the use of glass tubes to hold lenses, filters, and isolator cores in devices having multiple optical fiber ports.

FIG. 1 shows the structure of a prior art WDM coupler manufactured according to the first kind of design and packaging technology based on epoxy bonding. The WDM coupler includes a dual fiber pigtail 25, a GRIN lens 35, a WDM filter 40, a GRIN lens 50, and a single fiber pigtail 60. In a typical manufacturing process, the GRIN lens 35, the WDM filter 40 and the GRIN lens 50 are first fixed together by applying a heat-curing epoxy 45. The relative position of the GRIN lens 35 to the fiber pigtail 25 is adjusted to achieve a lowest transmission loss from the input fiber 15 to the output fiber 20 for optical signals having reflection wavelengths. Then the dual fiber pigtail 25 is fixed to the GRIN lens 35 by applying a heat-curing epoxy 30. Then the relative position of the GRIN lens 50 to the fiber pigtail 60 is adjusted to achieve a lowest transmission loss from the input fiber 15 to the output fiber 65 for optical signals having transmission wavelengths. And then, the single fiber pigtail 60 is fixed to the GRIN lens 50 by applying a heat-curing epoxy 55. The conventional method and system provides the WDM couplers with good performance and reliability suitable for many types of applications. However, the WDM couplers manufactured according to the conventional method and system have a risk of failure when they are applied in high power optical transmission systems. In general, the heat-curing epoxies inevitably spread over all the optical paths in the WDM couplers. More specifically, the heat-curing epoxies 30, 45 and 55 spread over the optical paths between the dual fiber pigtail 25 and the GRIN lens 35, between the GRIN lenses 35, 50 and the WDM filter 40 and between the GRIN lens 50 and the single fiber pigtail 60, respectively. Under long-term operation, the epoxies 30, 45 and 55 when exposed to the transmitted optical signals may gradually become degraded and susceptible to damages and thus lead to unreliable performance after continuously absorbing the optical signal energy. In the typical WDM coupler, the diameter of the optical signal beam is changing from about 10 m at the epoxy 30 to about 450 m at the epoxy 45 to about 10 m at the epoxy 55. Thus, the optical signal power densities at the epoxies 30 and 55 are about 2500 times higher than that at the epoxy 45. Therefore, the risk for high optical power damage is significantly higher at the epoxies 30 and 55 than at the epoxy 45. The difficulties are specially pronounced for transmission of optical signals of high power. Because of the heat absorption problem, many optical system designers and operators now prefer or even demand to have all optical paths of the WDM couplers epoxy-free. Due to the significantly high power density and thus reliability risk, as the first step toward all epoxy-free optical paths, the optical system designers and operators now require not to use any epoxy on the optical paths between the GRIN lenses and the fiber pigtails.

Improvements have been achieved by providing WDM couplers with an epoxy-free optical path. However, there are still problems in reducing insertion losses as a result of beam walk-off when a beam of light propagates between the various optical elements in a WDM coupler.

It is an object of this invention to provide an improved WDM coupler having an epoxy-free optical path.

It is a further object of the present invention to provide a WDM coupler having a more simple design, a improved performance, and/or improved reliability and environmental stability.

Another object of this invention is to provide lower cost WDM couplers.

### SUMMARY OF THE INVENTION

In accordance with the invention there is provided, a WDM coupler comprising a first optical fiber tube having two optical fibers securely held therein in a predetermined relationship, a first substantially focusing/collimating rod lens adjacent and optically coupled with the first optical fiber tube, said first substantially focusing/collimating rod lens having an input end face for receiving a beam of light from the first optical fiber tube and an output end face, an optical filter element adjacent and optically coupled with the first substantially focusing/collimating rod lens for receiving a beam of light from said first substantially focusing/collimating rod lens, a second substantially focusing/collimating rod lens adjacent and optically coupled with the optical element, said second substantially focusing/collimating rod lens having an input end face for receiving a beam of light from the optical element and an output end face, a second optical fiber tube adjacent and optically coupled with the second substantially focusing/collimating rod lens, said second optical fiber tube having at least one optical fiber contained therein, the second optical fiber tube being optically aligned with one of the two optical fibers contained in the first optical fiber tube, an inwardly facing end face of the second optical fiber tube and the output end face of the second substantially focusing/collimating rod lens are non-parallel for forming a non-zero angle therebetween.

In accordance with an embodiment of the invention the optical filter element is an at least partially reflective optical filter. In particular, the optical filter element is a WDM filter.

In accordance with a further embodiment, each of the first and the second substantially focusing/collimating rod lenses is a GRIN lens.

In yet a further embodiment, the pitch of the first GRIN lens is 0.245 and the pitch of the second GRIN lens is 0.23.

In accordance with another embodiment, the WDM coupler comprises a first, a second, and a third holding tube, said first holding tube for holding the first optical fiber tube therein, said second holding tube for holding the optical filter element and the first and second substantially focusing/collimating rod lens, and said third holding tube for holding the second optical fiber tube therein.

The first, second, and third holding tubes are fastened to each other for forming a first and a second joint therebetween.

In an embodiment of the present invention, the end faces of the first, second, and third holding tubes have a promoter provided thereon for preventing the WDM coupler from an exposure to moisture.

In another embodiment of the invention, the first, second, and third holding tubes are glass tubes made from a glass material having a substantially same coefficient of thermal expansion.

In a further embodiment of the present invention, the optical filter element and the first and second substantially focusing/collimating rod lens are disposed about a substantially same optical axis.

In yet a further embodiment of the invention, the second optical fiber tube is shifted in a parallel manner from the optical axis for performing an xyz alignment of the second optical fiber tube.

If desired, the WDM coupler further comprises an optical tap between the first and second substantially focusing/collimating rod lenses.

In accordance with an embodiment of the invention, an inwardly facing end face of the first optical fiber tube and the input end face of the first substantially focusing/collimating rod lens are parallel and slanted for reducing a back-reflection. For example, a polishing angle of 8 degrees of both end faces is used to reduce the effect of back-reflection.

In accordance with the invention, there is further provided, an optical coupling system comprising first and second back-to-back GRIN lenses each having an input and an output end face, an optical filter element disposed between the first and second back-to-back GRIN lenses, an input optical fiber tube having two optical fibers therein adjacent to and optically coupled with the first of the back-to-back GRIN lenses, an output optical fiber tube having an optical fiber therein adjacent to and optically coupled with the second of the back-to-back GRIN lenses, wherein an inwardly facing end face of the output optical fiber tube and the output end face of the second of the back-to-back GRIN lenses are non-parallel to each other for reducing coupling losses.

### BRIEF DESCRIPTION OF THE DRAWINGS

Exemplary embodiments of the invention will now be described in conjunction with the following drawings wherein like numerals represent like elements, and wherein:

FIG. 1 shows a cross-sectional view of a prior art WDM coupler based on epoxy bonding;

FIG. 2 shows a schematic side view of a beam walk-off between a pair of back-to-back GRIN lenses having an optical filter disposed therebetween;

FIG. 3 shows a schematic side view of a GRIN lens and a fiber pigtail wherein the walk-off of a light beam is compensated for by a polishing angle of the output end face of the GRIN lens and the inwardly facing end face of the fiber pigtail;

FIG. 4 shows a schematic side view of the coupling device in accordance with the invention presenting the optical path of a beam of light propagating through the coupling device;

FIG. 5 shows a schematic side view of the coupling device in accordance with another embodiment of the invention having the optical components arranged in holding tubes;

FIG. 6 is a schematic side view of a WDM coupling device presenting the internal propagation of light beams therethrough;

FIG. 7 shows a graph representing the edge of the Gaussian beams in the lens;

FIG. 8 shows a schematic view of the degrees of freedom for aligning the coupling device in accordance with the present invention; and

FIG. 9 presents a diagram relating predicted coupling losses between predetermined polishing angles of the second Grin lens and the single fiber pigtail when compensating a walk-0ff of a light beam through the coupling device.

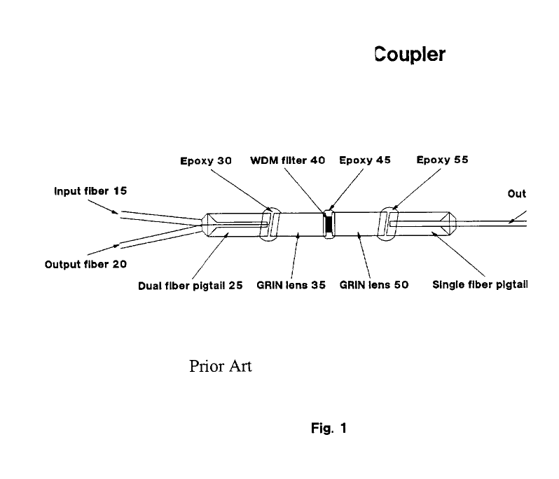

### DETAILED DESCRIPTION OF THE PREFERRED EMBODIMENTS

The present invention discloses a WDM coupler including fiber pigtails, graded index (GRIN) lenses, and a wavelength division multiplexed (WDM) filter. It is based on a technology and a packaging method providing an epoxy-free optical path. This requires the use of holding tubes or glass housings to which the optical components of the WDM coupler are glued rather than applying a glue between the components.

The use of GRIN lenses in optical coupling systems is well know. GRIN lenses are produced under the trade name “SELFOC”, a mark which is registered in Japan and owned by the Nippon Sheet and Glass Co. Ltd. Although the detailed description hereafter concerns GRIN lenses, aspects of this invention are also relevant to the use of other types of collimating lenses and should not be limited to graded index lenses.

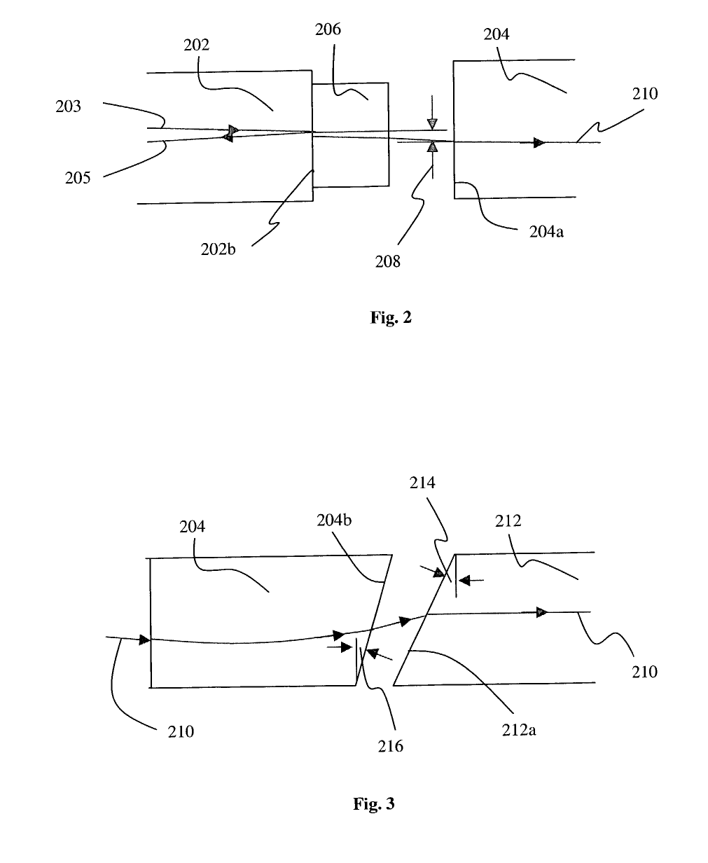

Turning now to FIGS. 2 and 3, the principle of the invention is explained. A first GRIN lens 202 is shown having an input beam 203 represented by a line with a directional arrow. At an output end face 202b of the GRIN lens 202 the input beam becomes collimated. A second GRIN lens 204 is disposed adjacent and optically coupled with the first GRIN lens 204 in a back-to-back relationship. Each GRIN lens is provided is provided with a port which is a point or a region along an input end face 202a (not shown), 204a or output end face 202b, 204b along the lenses 202, 204 for receiving or transmitting a beam of light. An at least partially reflective optical filter 206 is disposed between the first and the second GRIN lens 202, 204 and is shown to filter the incoming beam of light 203 by reflecting beam 205 backwards to another port on the input end face of GRIN lens 202. A portion of the light is passed through the filter 206 and is then transmitted via the input end face 204a of GRIN lens 204 to an output end face 204b thereof yielding an output beam 210. As can be seen from FIG. 2, a beam walk-off 208 occurs as a result from being passed through the WDM filter 206 and the distance between GRIN lenses 202, 204. However, in accordance with the present invention and as can be seen from FIG. 3, this beam walk-off is compensated for by creating a polishing angle 216 at the output end face 204b of GRIN lens 204 and a polishing angle 214 at an inwardly facing end face 212a of the single fiber pigtail 212. The polishing angles 214, 216 are selected so that the output end face 204 of lens 204 and the inwardly facing end face 212a of the single fiber pigtail 212 are non-parallel to each other so as to form a non-zero angle therebetween.

The following table presents a few examples of employed polishing angles as different types of filters have different walk-off. As a result, different polish angles of lens 204 and the fiber pigtail 212 are used:

| | | 200 G | | |
|---|---|---|---|---|
| | Wide band pass | narrow | 100 G | 50 G narrow |
| Filter | filter and edge | band pass | narrow band | band pass |
| type | filter | filter | pass filter | filter |
| Lens2 polish | 8 | 6 | 6 | 6 |
| angle | | | | |
| Single | 10 | 9 | 10 | 13 |
| pigtail | | | | |
| polish | | | | |
| angle | | | | |

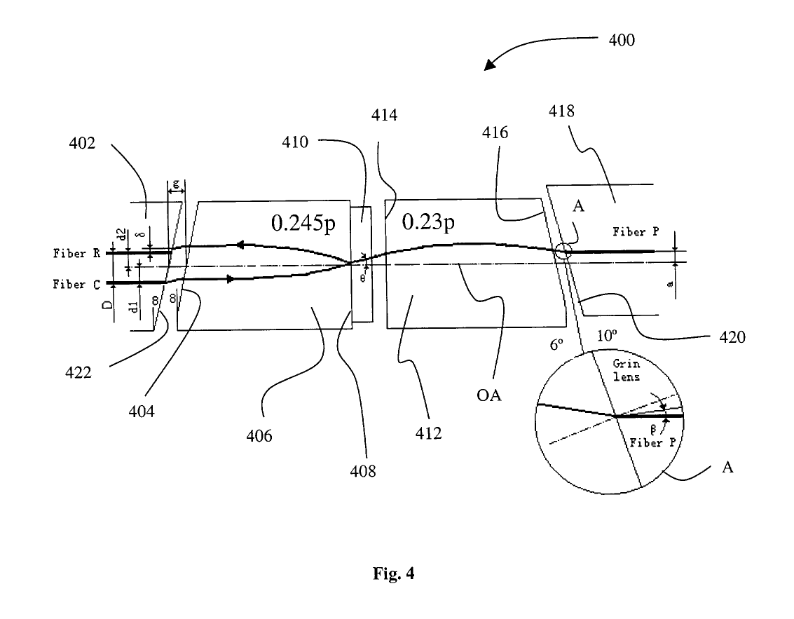

FIG. 4 shows a more detailed view of a WDM coupler 400 in accordance with the present invention. A dual fiber pigtail 402 is shown on the left having two fibers R and C securely held therein. Fibers R and C are held therein in a predetermined relationship. Fiber R is disposed at a distance d2 from the optical axis OA of WDM coupler 400. Fiber C is disposed at a distance d1 from the optical axis OA. The distance D between fibers R and C corresponds to the sum of d1 and d2. FIG. 4 shows a light beam being launched into fiber C of coupler 400, as indicated by a directional arrow, via an input end face 404 of a GRIN lens 406. At an output end face 408 of lens 406 a portion of the beam of light is reflected and returned to fiber R as indicated by the directional arrow. Another portion of the light is passed through filter 410 which is disposed at the output end face 408 of lens 406. The filtered beam then propagates into GRIN lens 412 via input end face 414 and exits lens 412 at an output end face 416. The filtered beam then enters the single fiber pigtail P via an inwardly facing end face 420 of fiber pigtail 418. The walk-off of the filtered beam as a result of being passed through filter 410 and a distance between the lenses 406, 412 is compensated for by polishing output end face 416 of lens 412 and the inwardly facing end face 420 of fiber pigtail 418. End face 416 and end face 420 are polished such that they are non-parallel to each other resulting in a non-zero angle between both end faces. In the example (100G) presented in FIG. 4, end face 416 is shown to be polished at an angle of 6 degrees and end face 420 is shown to be polished at an angle of 10 degrees. A close-up A shows the beam propagation between both end faces in more detail. In accordance with the present invention, the first GRIN lens 406 has a pitch of 0.245 and the second GRIN lens 412 has a pitch of 0.23. The polishing angles of the output end face of the second GRIN lens and the inwardly facing end face of the fiber pigtail are designed so as to make β=0°, and to minimize aninsertion loss from fiber C to fiber P. The use of a 0.245 pitch GRIN lens 406 can provide for low insertion loss from the common port C to the return port R because the reflection face of the filter 410 is almost in the focal plane of GRIN lens 406.

Furthermore, FIG. 4 shows the inwardly facing end face 422 of dual fiber pigtail 402 and the input end face 404 of lens 406 to be polished at an angle of 8 degrees each so as to reduce an unwanted effect of back-reflection.

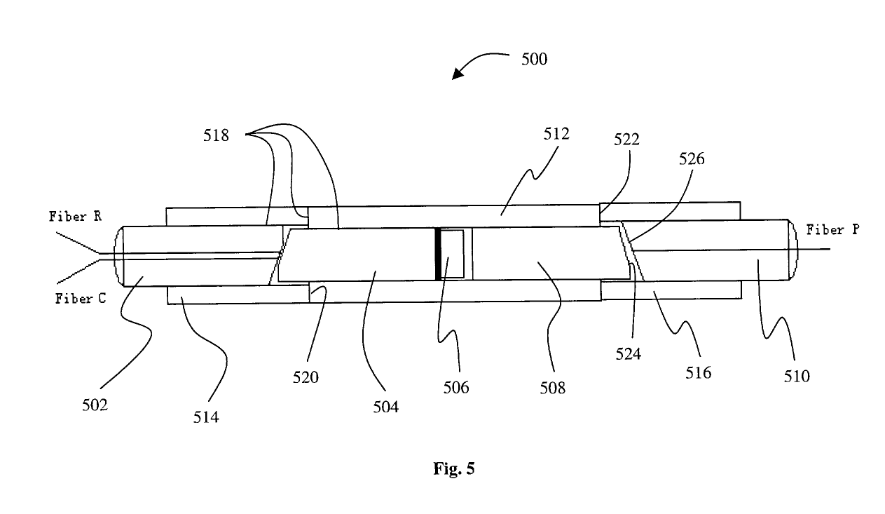

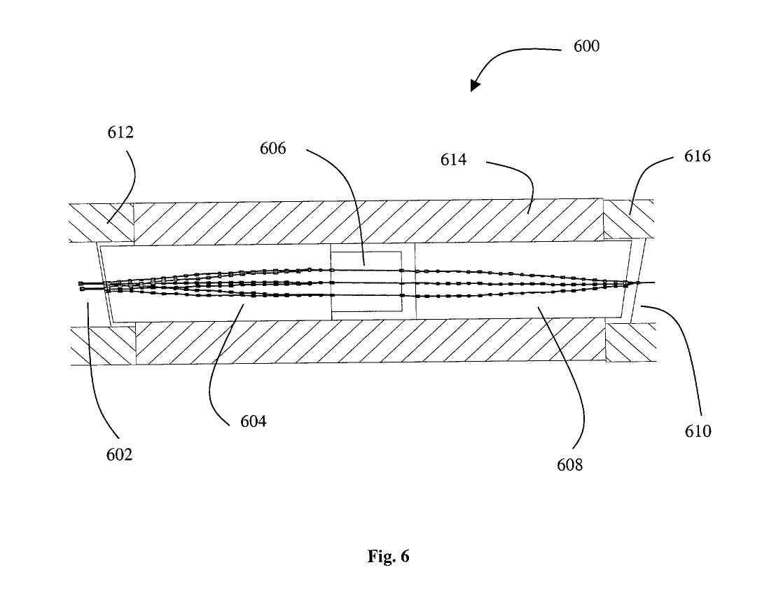

Another aspect of the invention is shown in conjunction with FIG. 5 making use of glass holding tubes for aligning and gluing the coupler components therein so as to create an epoxy-free optical path. Coupler 500 includes a dual fiber pigtail 502 holding securely two fibers R and C therein, a first GRIN lens 504, a WDM filter 506, a second GRIN lens 508, a single pigtail 510 securely holding a fiber P therein, a first holding tube 512 for holding the filter 506 and the first and second GRIN lenses 504, 508, a second holding 514 for holding the dual fiber pigtail 502 therein, and a third holding tube 516 for holding the single fiber pigtail 510 therein. An epoxy resin 518 is used to glue the components to the holding tubes and also to glue the holding tubes to each other, thereby creating two joints 520, 522 between the first and the second holding tube and the first and the third holding tube, respectively. The two joints are realized and fastened by injecting an epoxy into the gap between the end faces of holding tubes and the gap between the end faces of the holding tubes and the pigtail under a temperature of 105 degrees and allowing a curing time of 5 minutes.

The first and the second GRIN lenses 504, 508 are arranged in one holding tube 512 having a same optical axis OA as shown in FIG. 5. The beam walk-off is compensated for by polishing angles of end face 524 of the second GRIN lens 508 and the inwardly facing end face 526 of fiber pigtail 510 in order to center the beam of light entering the single fiber pigtail 510 as it propagates along the fiber axis to get low coupling losses. In accordance with an embodiment of the invention, only an xyz alignment of the pigtail is used as can be seen from FIG. 5 wherein the single fiber pigtail is slightly translated in an upwards direction from the optical axis OA.

In accordance with a further embodiment of the present invention, all components of the coupler device 500, including the holding tube, are made of a glass material having a substantially same coefficient of thermal expansion. This results in good TDL values and since there is no epoxy in the optical path, such coupling devices are good for high power reliability.

The use of a 0.245 pitch GRIN lens as the first lens allows to obtain low insertion losses from the common port C to the return port R because the reflection face of the filter is almost in the focal plane of the first lens while preventing an epoxy from entering a gap between the dual fiber pigtail and the first lens.

If the pitch of the first Grin lens was less than 0.245, the R port insertion loss will increase. If the pitch of the first Grin lens was larger than 0.245, the epoxy glue will enter the gap between the dual fiber pigtail and the first lens. The second Grin lens or Pass port lens uses a 0.23 pitch because the gap is big and easy to operate while having a low coupling loss.

In accordance with yet a further embodiment of the invention, the first, second, and third holding tubes are glass tubes and prevent two joints from being destroyed by moisture and hence, greatly improve the reliability of these kind of devices.

In another embodiment of the invention, the end faces of the first, second, and third holding tubes are treated with a promoter resulting in a strong joint which prevents the two joints from being destroyed by moisture and furthermore also increases the reliability of the device.

FIG. 6 is a schematic side view of a WDM coupling device 600 presenting the internal propagation of light beams therethrough. A light beam is launched into one of the two ports of a dual fiber pigtail 602 and propagates via a first Grin lens 604, a WDM filter 606, and a second Grin lens 608 to an output fiber held in a single fiber pigtail 610. Device 600 is supported in glass sleeves 612 holding the dual fiber pigtail, glass sleeve 614 holding the first and the second Grin lens 604 and 608, and the WDM filter 606, and a glass sleeve 616 holding the single fiber pigtail 610. The first lens 604 has a pitch of 0.245 with an 8 degree polishing angle, and the second lens 608 has a pitch of 0.23 with an 8 degree polishing angle. The dual fiber pigtail in this example has an 8 degree polishing angle and the single fiber pigtail has a 10 degree polishing angle. The filter has a thickness of 1.5 mm. The predicted coupling loss for such a 100 G device is <0.01 dB.

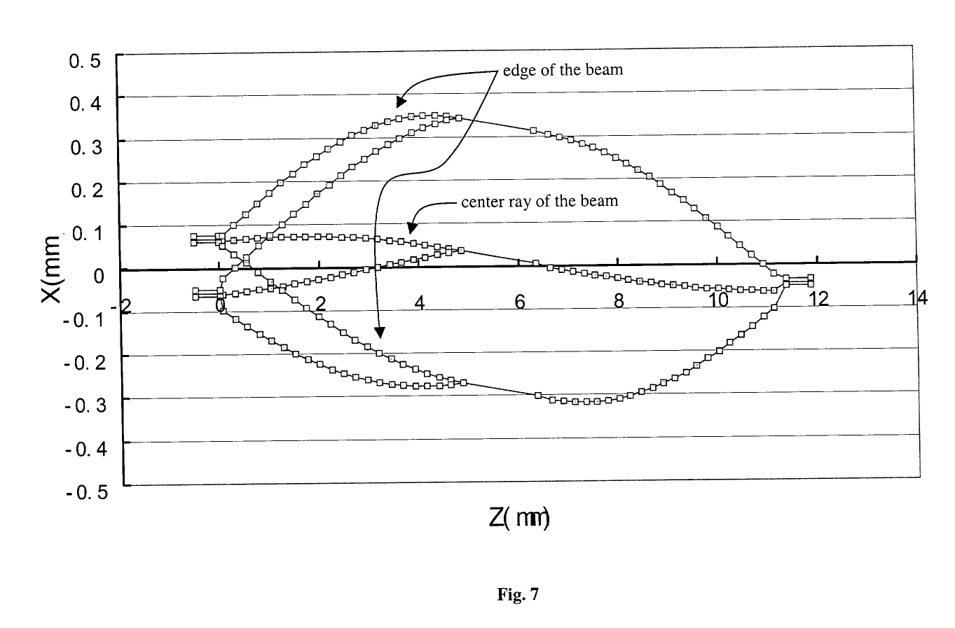

FIG. 7 shows a graph representing the edge of the Gaussian beams in the lens.

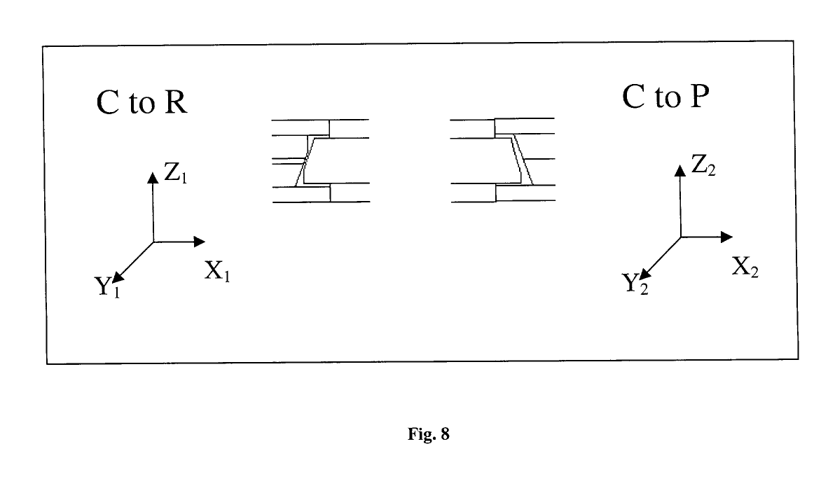

FIG. 8 shows a schematic view of the degrees of freedom for aligning the coupling device in accordance with the present invention. There is a total of six degrees of freedom for alignment. The dual fiber pigtail and the Grin lenses are not rotated. The normal plane of the polished end face is in the same plane. An xyz alignment of the single fiber pigtail is the only required alignment by translating the single fiber pigtail away from the optical axis until the light speckles are aligned. No angular match is required as this is performed by introducing different polishing angles of the end faces of the Grin lens and the inwardly facing end face of the single fiber pigtail.

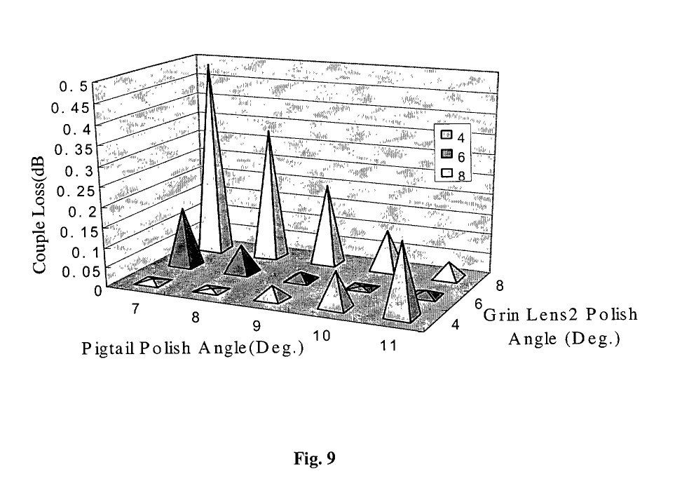

FIG. 9 presents a diagram relating predicted coupling losses between predetermined polishing angles of the second Grin lens and the single fiber pigtail when compensating a walk-off of a light beam passing through a coupling device in accordance with the present invention.

The present invention has several advantages over prior art coupling devices as it presents a simpler design, a better performance, a higher reliability and environmental stability, a short process time, it is easy to manufacture automatically, and is of lower cost.

When comparing the structure of the device in accordance with the present invention to solder and laser welded WDM couplers it has a more simple structure as it contains fewer parts in the device.

In addition, the optical components also have a simpler shape. Another advantage as stated above is that the manufacturing process is simple because the alignment process is simple since the R and P port only use an xyz alignment and no rotation or tilt adjustment. The solder platform requires a difficult tilt adjust and the laser welding platform requires rotation with a difficult automation. Further, the solder platform often causes large pass port insertion losses and hence an advanced technology is needed to lower the insertion loss changes.

Advantageously, the environmental performance of coupling devices in accordance with the invention are good. Devices in accordance with the present invention have a similar reliability as laser welded devices, and a better reliability than soldered WDM couplers. WDM couplers of the present invention pass the 2000 hr 85/85 damp heat test which soldered WDM couplers do not pass since they often cannot be airproofed. In this case, vapors enter into the metal inter housing destroying the joint between the dual fiber pigtail and the R port lens, and also the filter mounting. This will result in large insertion losses (IL) and eventually a device failure. In WDM coupling devices of the present invention, the glass tube end face is modified by a promoter, so that vapors cannot destroy the joints between the glass holding tubes. Furthermore, it is also difficult for vapors to enter the gap between the pigtail and the lens through the epoxy between the pigtail holding tubes ID and pigtail OD because the distance is long. On the other hand, the WDM filter is disposed in the center glass tube and between two lenses, so the epoxy path between the lens OD and the glass tube ID is long. Thus, the WDM filter is protected well and it is more difficult for vapors to get to the WDM filter.

Another advantage of WDM couplers of the present invention is their low cost The equipment is simple, and fewer parts are used in the device and an easy operation result in less labor and hence lower cost.

Some exemplary specifications of WDM couplers in accordance with the invention are better IL, TDL and reliability than soldered devices. For example, TDL of a soldered device is 0.30 dB and that of a WDM coupler in accordance with the invention is 0.1 dB. For C to R, the IL of a soldered device is 0.6 dB and that of a WDM coupler of the present invention is 0.4 dB. For C to P, the IL of a soldered device is 1.2-1.5 dB and that of a WDM coupler of the present invention is 0.8 dB.

A further advantage is a simple automation process as in comparison to laser welded devices, for example, since only an XYZ alignment is needed. If the automation process requires rotation and tilt adjust during the alignment, it will be more difficult to automate this process.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. A WDM coupler comprising:
a first optical fiber tube having two optical fibers securely held therein in a predetermined relationship;
a first substantially focusing/collimating rod lens adjacent and optically coupled with the first optical fiber tube, said first substantially focusing/collimating rod lens having an input end face for receiving a beam of light from the first optical fiber tube and an output end face;
an optical filter element adjacent and optically coupled with the first substantially focusing/collimating rod lens for receiving a beam of light from said first substantially focusing/collimating rod lens;
a second substantially focusing/collimating rod lens adjacent and optically coupled with the optical element, said second substantially focusing/collimating rod lens having an input end face for receiving a beam of light from the optical element and an output end face;
a second optical fiber tube adjacent and optically coupled with the second substantially focusing/collimating rod lens, said second optical fiber tube having at least one optical fiber contained therein, the second optical fiber tube being optically aligned with one of the two optical fibers contained in the first optical fiber tube, an inwardly facing end face of the second optical fiber tube and the output end face of the second substantially focusing/collimating rod lens are non-parallel for forming a non-zero angle therebetween.

2. The WDM coupler as defined in claim 1 wherein the optical filter element is an at least partially reflective optical filter.

3. The WDM coupler as defined in claim 2 wherein each of the first and the second substantially focusing/collimating rod lenses is a GRIN lens.

4. The WDM coupler as defined in claim 3 wherein the pitch of the first GRIN lens is 0.245 and the pitch of the second GRIN lens is 0.23.

5. The WDM coupler as defined in claim 1 further comprising a first, a second, and a third holding tube, said first holding tube for holding the first optical fiber tube therein, said second holding tube for holding the optical filter element and the first and second substantially focusing/collimating rod lens, and said third holding tube for holding the second optical fiber tube therein.

6. The WDM coupler as defined in claim 5 wherein the first, second, and third holding tubes are fastened to each other for forming a first and a second joint therebetween.

7. The WDM coupler as defined in claim 6 wherein end faces of the first, second, and third holding tubes have a promoter provided thereon for preventing the WDM coupler from an exposure to moisture.

8. The WDM coupler as defined in claim 5 wherein the first, second, and third holding tubes are glass tubes made from a glass material having a substantially same coefficient of thermal expansion.

9. The WDM coupler as defined in claim 5 wherein the optical filter element and the first and second substantially focusing/collimating rod lens are disposed about a substantially same optical axis.

10. The WDM coupler as defined in claim 9 wherein the second optical fiber tube is shifted in a parallel manner from the optical axis for performing an xyz alignment of the second optical fiber tube.

11. The WDM coupler as defined in claim 1 further comprising an optical tap between the first and second substantially focusing/collimating rod lenses.

12. The WDM coupler as defined in claim 1 wherein an inwardly facing end face of the first optical fiber tube and the input end face of the first substantially focusing/collimating rod lens are parallel and slanted for reducing a back-reflection.

13. An optical coupling system comprising:
first and second back-to-back GRIN lenses each having an input and an output end face;
an optical filter element disposed between the first and second back-to-back GRIN lenses;
an input optical fiber tube having two optical fibers therein adjacent to and optically coupled with the first of the back-to-back GRIN lenses;
an output optical fiber tube having an optical fiber therein adjacent to and optically coupled with the second of the back-to-back GRIN lenses;
wherein an inwardly facing end face of the output optical fiber tube and the output end face of the second of the back-to-back GRIN lenses are non-parallel to each other for reducing coupling losses.
